(19) United States
(12) Patent Application Publication
(10) Pub. No.: US 2026/0276785 A1
(43) Pub. Date: Sep. 17, 2026

(54) OBJECT DETECTION DEVICE AND OBJECT DETECTION METHOD

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventor: Seiya FUJITSU, Tokyo (JP)

(21) Appl. No.: 19/563,669

(22) Filed: Mar. 11, 2026

(30) Foreign Application Priority Data
Mar. 13, 2025 (JP) 2025-040341

(51) Int. Cl. G01S 7/41; B60W 50/14; G01S 13/931

(52) U.S. Cl. CPC G01S 7/415; B60W 50/14; G01S 13/931

(57) ABSTRACT

An object detection device for detecting an object approaching a host vehicle from a diagonally rearward direction is disclosed. A segment-information acquisition unit is configured to acquire segment information about a position and a movement state of a segment presumed to be an object and generated using a radar sensor having detection regions located diagonally rearward of the host vehicle. A ghost determination unit is configured to determine that the segment is a ghost when the segment information meets a ghost determination condition. The ghost determination condition includes a first condition that a segment travel direction is along a cross-range direction of the radar sensor, a second condition that the segment travel direction and a host-vehicle travel direction intersect forward of the host vehicle, and a third condition that a center position of the segment is located forward of a predefined boundary position.

### CROSS-REFERENCE TO RELATED APPLICATION

This application is based on and claims the benefit of priority from earlier Japanese Patent Application No. 2025-040341 filed Mar. 13, 2025, the description of which is incorporated herein by reference.

### BACKGROUND

### Technical Field

The present disclosure relates to an object detection device and an object detection method for detecting an object approaching a host vehicle from a diagonally rearward direction.

### Related Art

A known object detection device detects an object located diagonally rearward of a host vehicle and outputs to a driver a warning indicative of the detected object.

### BRIEF DESCRIPTION OF THE DRAWINGS

In the accompanying drawings:

FIG. 1 is a schematic diagram illustrating a state in which another vehicle is approaching from a right-rear side of a vehicle to which the present disclosure is applied;

FIG. 2 is a block diagram illustrating a schematic device configuration of an on-board system illustrated in FIG. 1;

FIG. 3 is a block diagram illustrating a schematic functional configuration implemented by the object detection device illustrated in FIG. 2;

FIG. 4A is a conceptual diagram illustrating an example of an operational overview of the object detection device illustrated in FIG. 3;

FIG. 4B is a conceptual diagram illustrating an example of an operational overview of the object detection device illustrated in FIG. 3;

FIG. 5A is a conceptual diagram illustrating an example of an operational overview of the object detection device illustrated in FIG. 3;

FIG. 5B is a conceptual diagram illustrating an example of an operational overview of the object detection device illustrated in FIG. 3;

FIG. 6A is a conceptual diagram illustrating an example of an operational overview of the object detection device illustrated in FIG. 3;

FIG. 6B is a conceptual diagram illustrating an example of an operational overview of the object detection device illustrated in FIG. 3;

FIG. 7 is a conceptual diagram illustrating an example of an operational overview of the object detection device illustrated in FIG. 3;

FIG. 8 is a conceptual diagram illustrating an example of an operational overview of the object detection device illustrated in FIG. 3;

FIG. 9 is a conceptual diagram illustrating an example of an operational overview of the object detection device illustrated in FIG. 3;

FIG. 10 is a flowchart illustrating an outline of one example of an operation of the object detection device illustrated in FIG. 3;

FIG. 11 is a flowchart illustrating an outline of one example of an operation of the object detection device illustrated in FIG. 3; and

FIG. 12 is a flowchart illustrating an outline of one example of an operation of the object detection device illustrated in FIG. 3.

### DESCRIPTION OF SPECIFIC EMBODIMENTS

For example, when a host vehicle travels diagonally to change lanes, the known object detection device may erroneously detect a stationary fixed object, such as a wall or a guardrail extending along a road, as another vehicle approaching the host vehicle from a diagonally rearward direction. Such a false target that is erroneously detected as another vehicle is referred to as a ghost. When detection of such a ghost causes an unnecessary false warning or erroneous notification, usability of this type of device deteriorates.

The present disclosure has been made in view of the circumstances exemplified above. That is, the present disclosure provides a technique that enables preferable suppression of occurrence of false warnings or erroneous notifications, for example, by more reliably detecting an object approaching a host vehicle from a diagonally rearward direction.

A first aspect of the present disclosure provides an object detection device (4) for detecting an object (Bt) approaching a host vehicle (Bs) from a diagonally rearward direction. The object detection device includes: a segment-information acquisition unit (403) configured to acquire segment information about a position and a movement state of a segment (Sg), the segment being a region presumed to be an object and generated based on transmission and reception results of radar waves by a radar sensor (2) having detection regions (RdL, RdR) located diagonally rearward of the host vehicle; and a ghost determination unit (404) configured to determine, based on the segment information, whether the segment is a ghost. The ghost determination unit is further configured to determine that the segment is a ghost when the segment information meets a ghost determination condition. The ghost determination condition includes: a first condition that a segment travel direction (Vt) of the segment is a direction along a cross-range direction (Dx) of the radar sensor; a second condition that the segment travel direction and a host-vehicle travel direction (Vs) of the host vehicle intersect forward of the host vehicle; and a third condition that, at a time point when the segment is generated, a center position (Psg) of the segment is located forward of a predefined boundary position (L1) defined with reference to a mounting position (Xs) of the radar sensor in a longitudinal direction of the host vehicle.

A second aspect of the present disclosure provides an object detection method of detecting an object (Bt) approaching the host vehicle (Bs) from a diagonally rearward direction. The object detection method includes: acquiring segment information about a position and a movement state of a segment (Sg), the segment being a region presumed to be an object and generated based on transmission and reception results of radar waves by a radar sensor (2) having detection regions (RdL, RdR) located diagonally rearward of the host vehicle; and determining, based on the segment information, whether the segment is a ghost. The determining includes determining that the segment is a ghost when the segment information meets a ghost determination condition. The ghost determination condition includes: a first condition that a segment travel direction (Vt) of the segment is a direction along a cross-range direction (Dx) of the radar sensor; a second condition that the segment travel direction and a host-vehicle travel direction (Vs) of the host vehicle intersect forward of the host vehicle; and a third condition that, at a time point when the segment is generated, a center position (Psg) of the segment is located forward of a predefined boundary position (L1) defined with reference to a mounting position (Xs) of the radar sensor in a longitudinal direction of the host vehicle.

A third aspect of the present disclosure provides a computer program product including instructions which, when executed by a computer, cause the computer to perform an object detection method. The object detection method includes: acquiring segment information about a position and a movement state of a segment (Sg), the segment being a region presumed to be an object and generated based on transmission and reception results of radar waves by a radar sensor (2) having detection regions (RdL, RdR) located diagonally rearward of the host vehicle; and determining, based on the segment information, whether the segment is a ghost. The determining further includes determining that the segment is a ghost when the segment information meets a ghost determination condition, the ghost determination condition including: a first condition that a segment travel direction (Vt) of the segment is a direction along a cross-range direction (Dx) of the radar sensor; a second condition that the segment travel direction and a host-vehicle travel direction (Vs) of the host vehicle intersect forward of the host vehicle; and a third condition that, at a time point when the segment is generated, a center position (Psg) of the segment is located forward of a predefined boundary position (L1) defined with reference to a mounting position (Xs) of the radar sensor in a longitudinal direction of the host vehicle.

In each part of the present application document, the reference signs in parentheses attached to the components or the like merely indicate examples of the correspondence between the components or the like and the specific components described in relation to the embodiments described below. Therefore, the present disclosure is not limited by the above reference signs.

### Embodiments

Hereinafter, exemplary embodiments and specific examples of the present disclosure will be described with reference to the accompanying drawings as appropriate. It should be noted that the following embodiments, their modifications, and the accompanying drawings are schematically or simplistically presented for the purpose of concisely explaining the content of the present disclosure, and therefore do not limit the scope of the present disclosure in any way. Accordingly, it goes without saying that the configurations illustrated in the drawings do not necessarily coincide with the specific device configurations that may actually be manufactured and marketed. That is, unless the applicant explicitly limits the scope of the present application during prosecution, the present disclosure should not be construed in a limited manner based on the illustrations in the drawings and the descriptions of the corresponding device configurations, functions, or operations set forth below.

### On-Board System Configuration

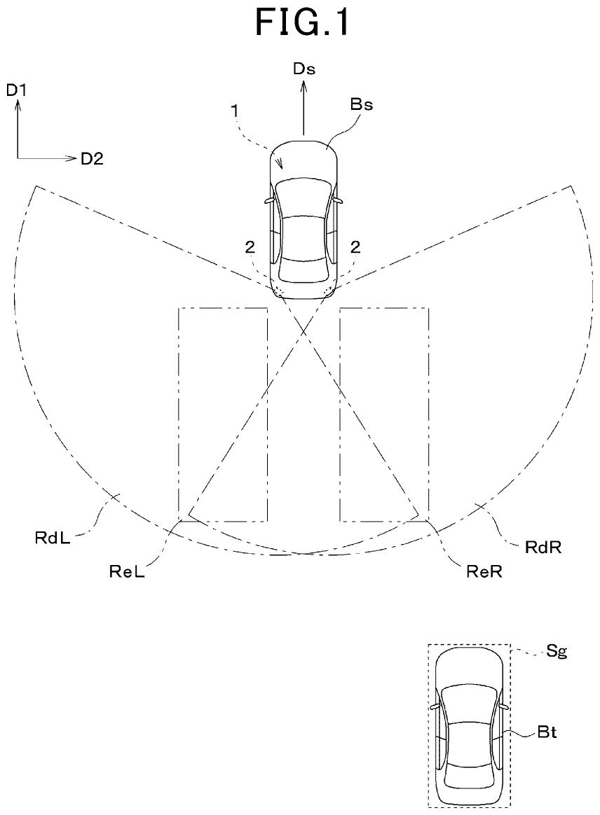

Referring first to FIG. 1, an on-board system 1 is configured to be mounted to a vehicle and to perform various operations in the vehicle. Hereinafter, a vehicle equipped with the on-board system 1 according to the present embodiment is referred to as the host vehicle Bs. The host vehicle Bs is a so-called ordinary-sized vehicle that is capable of traveling on roads and has a box-shaped vehicle body.

In FIG. 1, a vehicle longitudinal direction D1 is a direction that defines an overall length of a vehicle body of the host vehicle Bs and is perpendicular to a vehicle lateral direction D2. The vehicle longitudinal direction D1 is parallel to a travel direction Ds of the host vehicle. The travel direction Ds of the host vehicle is a direction in which the host vehicle Bs travels and faces while the host vehicle Bs is traveling straight. When the host vehicle Bs is not traveling straight, the travel direction Ds is a tangential direction of a travel trajectory. Hereinafter, a position in the vehicle longitudinal direction D1 or in the travel direction Ds of the host vehicle is referred to as a longitudinal position.

The on-board system 1 is configured to perform various operations of the host vehicle Bs, including a warning operation, based on detection results of objects such as other vehicles Bt around the host vehicle Bs acquired using radar sensors 2. Each radar sensor 2 is, for example, a millimeter-wave radar sensor.

As illustrated in FIG. 1, candidates of detection results of objects around the host vehicle Bs using the radar sensors 2 are acquired, that is, calculated as segments Sg. Each segment Sg is a polygon that is generated using one or more reflection points and is estimated to encompass an outer shape of an object around the host vehicle Bs, and is typically a rectangle. Each reflection point is a point corresponding to a position on an object at which the object is estimated to have reflected a radar wave emitted from the radar sensors 2.

In the present embodiment, a pair of radar sensors 2 are provided at a rear end portion of the vehicle body of the host vehicle Bs on left and right sides, each radar sensor 2 having a detection region located diagonally rearward of the host vehicle Bs. The on-board system 1 is configured to notify an occupant such as a driver of the host vehicle Bs of approach between the host vehicle Bs and an object, based on detection information of an object located diagonally rearward of the host vehicle Bs acquired by the radar sensors 2.

Specifically, the on-board system 1 is configured to set a left-rear notification region ReL within a left-rear detection region RdL and to set a right-rear notification region ReR within a right-rear detection region RdR. In the following description, the left-rear notification region ReL and the right-rear notification region ReR are collectively referred to as a notification region.

The left-rear detection region RdL defines a detection range of the radar sensor 2 mounted to a left-rear end portion of the vehicle body of the host vehicle Bs and is formed in a fan shape in plan view as illustrated in FIG. 1. The right-rear detection region RdR defines a detection range of the radar sensor 2 mounted to a right-rear end portion of the vehicle body of the host vehicle Bs and is formed in a fan shape in plan view.

The left-rear notification region ReL is a virtual rectangular region that is deployed left-rearward of the host vehicle Bs from the mounting position of the radar sensor 2 within the left-rear detection region RdL and that is parallel to the vehicle longitudinal direction D1 and a vehicle lateral direction D2. The right-rear notification region ReR is a virtual rectangular region that is deployed right-rearward of the host vehicle Bs from the mounting position of the radar sensor 2 within the right-rear detection region RdR and that is parallel to the vehicle longitudinal direction D1 and the vehicle lateral direction D2.

The on-board system 1 is configured to provide a notification of approach of another vehicle Bt toward the host vehicle Bs from a diagonally rearward direction when the other vehicle Bt is detected within the notification region. The other vehicle Bt may be a two-wheeled vehicle such as a motorcycle, in addition to an automobile. The notification may be paraphrased as a warning.

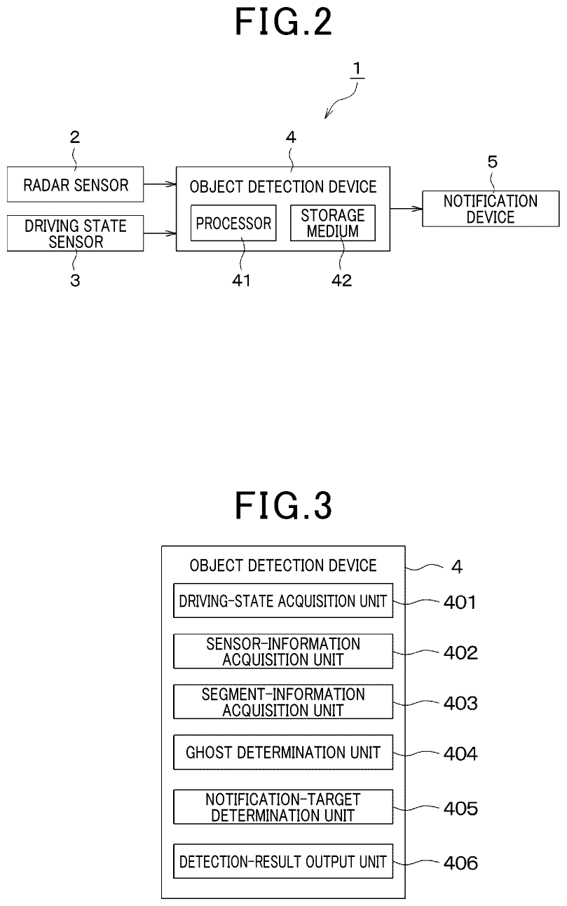

Referring to FIG. 2, the on-board system 1 includes, in addition to the radar sensors 2, a driving-state sensor 3, an object detection device 4, and a warning device 5. The radar sensor 2 and the driving-state sensor 3 are connected to the object detection device 4 via an on-board network to transmit outputs thereof to the object detection device 4. The object detection device 4 and the warning device 5 are connected via the onboard network and are configured to exchange information and signals.

The driving-state sensor 3 is provided to detect various quantities related to a driving state of the host vehicle Bs. The driving state includes a driving-operation state and a driving-behavior state of the host vehicle Bs. The driving-operation state is a state of driving-operation inputs for the host vehicle Bs by an occupant of the host vehicle Bs (typically a driver) or by a driving control ECU and includes, for example, an accelerator position, a brake operation amount, a steering amount, a shift range, and the like. ECU is an abbreviation for Electronic Control Unit. The driving-behavior state is a state related to motion or behavior of the host vehicle Bs and includes, for example, a vehicle speed, an acceleration, a yaw rate, and the like.

That is, the driving-state sensor 3 is a generic term for well-known on-board sensors such as a pedal-operation-amount sensor, a steering-amount sensor, a vehicle-speed sensor, and a yaw-rate sensor. The driving-state sensor 3 may further include a locator for acquiring position information of the host vehicle Bs.

The object detection device 4 is a so-called object-detection ECU and is configured to detect objects around the host vehicle Bs based on outputs of the radar sensors 2 and the driving-state sensor 3. Specifically, in the present embodiment, the object detection device 4 detects presence and a relative speed of an object such as another vehicle Bt approaching the host vehicle Bs from a diagonally rearward direction. The object detection device 4 outputs detection results of such an object and control commands, based on the detection results, to units of the host vehicle Bs such as the warning device 5.

The warning device 5 includes an audio output device that generates a warning sound and a visual output device that performs display or light emission for a warning. As the visual output device for notifying approach of another vehicle Bt from a diagonally rearward direction, for example, a head-up display device or a light-emitting device provided on a side mirror or the like may be used.

Thus, the on-board system 1 has a configuration as a blind-spot monitoring system that notifies an occupant of the host vehicle Bs of approach between the host vehicle Bs and an object such as another vehicle Bt based on object detection information about objects around the host vehicle Bs provided by the object detection device 4. Another vehicle Bt that is a target of such notification is referred to as a notification target. In contrast, a ghost is what is erroneously detected as if another vehicle Bt exists, for some reason, even though another vehicle Bt that should be a notification target does not actually exist.

In the present embodiment, the object detection device 4 has a configuration as an on-board computer including at least a processor 41 and a storage medium 42. The processor 41 includes at least one CPU or MPU. CPU is an abbreviation for Central Processing Unit. MPU is an abbreviation for Micro Processor Unit.

The storage medium 42 includes at least one non-transitory tangible storage medium such as a ROM or a non-volatile rewritable memory. ROM is an abbreviation for Read Only Memory. A non-volatile rewritable memory is a storage device that allows information to be rewritten while power is on and retains the information without allowing rewriting while power is off and is, for example, a flash ROM.

The storage medium 42 stores, together with a computer program, various data such as initial values, maps, and lookup tables that are required to execute the computer program. That is, the object detection device 4 is configured to perform an object detection operation by causing the processor 41 to load and execute an object detection program stored in the storage medium 42.

### Object Detection Device

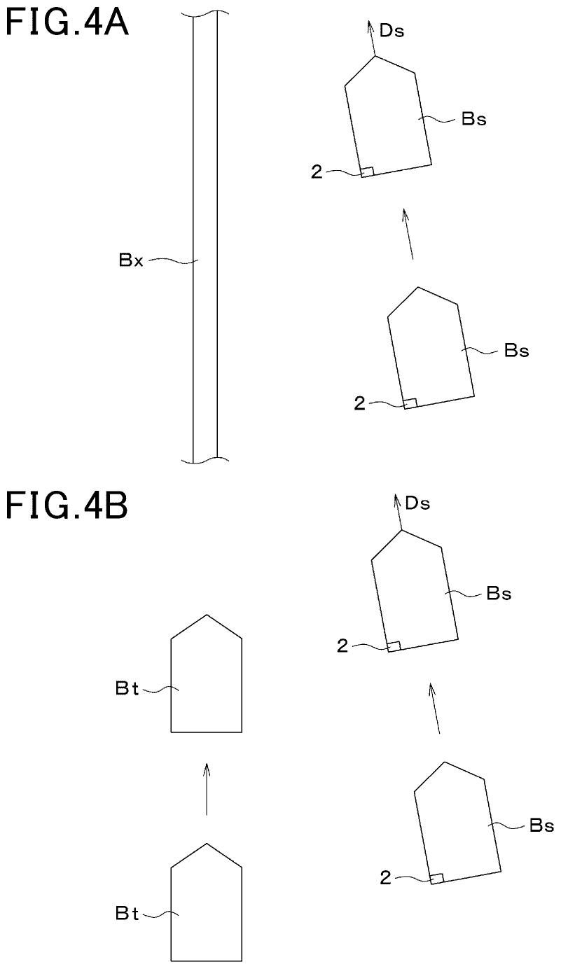

FIG. 3 illustrates an example of functional blocks implemented by causing the processor 41 included in the object detection device 4 to load and execute the object detection program, which is a computer program, from the storage medium 42. FIG. 4 illustrates an overview of an object detection operation by the object detection device 4 illustrated in FIG. 3. In the following, an overview of functional blocks and operation of the object detection device 4 according to the present embodiment will be described with reference to FIGS. 3 and 4.

As illustrated in FIG. 3, the object detection device 4 includes, as functional blocks implemented by executing the computer program, a driving-state acquisition unit 401, a sensor-information acquisition unit 402, a segment-information acquisition unit 403, a ghost determination unit 404, a notification-target determination unit 405, and a detection-result output unit 406. Details of these functional blocks will be described below. These functional blocks are provided for convenience to describe functions achieved by the object detection device 4 and do not mean that corresponding software routines or hardware units exist separately and independently from one another.

The driving-state acquisition unit 401 is configured to acquire a driving state of the host vehicle Bs based on outputs of the driving-state sensor 3. Such a driving state includes driving-operation quantities such as a steering amount, in addition to physical quantities related to driving behavior such as a vehicle speed and a yaw rate of the host vehicle Bs. Such a driving state may further include position information of the host vehicle Bs acquired by the locator. That is, the driving-state acquisition unit 401 temporarily stores, at least up to a predefined capacity, information input from the driving-state sensor 3.

The sensor-information acquisition unit 402 is configured to acquire information on transmission and reception results of radar waves by the radar sensors 2. That is, the sensor-information acquisition unit 402 receives, from the radar sensors 2 having the left-rear detection region RdL and the right-rear detection region RdR as detection regions, information corresponding to object detection results, and temporarily stores the information at least up to a predefined capacity.

The segment-information acquisition unit 403 is configured to acquire segment information based on information acquired by the driving-state acquisition unit 401 and the sensor-information acquisition unit 402. The segment information is information about a position and a movement state of a segment Sg generated based on transmission and reception results of radar waves by the radar sensors 2. In the present embodiment, the segment-information acquisition unit 403 generates, that is, calculates the segment Sg based on information acquired by the driving-state acquisition unit 401 and the sensor-information acquisition unit 402. The segment-information acquisition unit 403 time-sequentially stores the acquired segment information temporarily at least up to a predefined capacity.

When a detected object is another vehicle Bt that is an ordinary-sized vehicle, the segment Sg is typically a rectangle having sides parallel to the first axis and the second axis described above and having substantially the same size as the host vehicle Bs. The position and movement state of the segment Sg may be expressed using, for example, two-dimensional coordinates having a first axis parallel to the vehicle longitudinal direction D1 and a second axis parallel to the vehicle lateral direction D2, with a predefined position in the host vehicle Bs (for example, a vehicle center position) as an origin.

The ghost determination unit 404 is configured to determine whether the segment Sg is a ghost based on the segment information acquired by the segment-information acquisition unit 403. Specifically, the ghost determination unit 404 determines that the segment Sg is a ghost when the segment information meets a predefined ghost determination condition. Details of the ghost determination condition will be described later.

The notification-target determination unit 405 is configured to determine whether a notification target is present based on a determination result by the ghost determination unit 404. The notification target is an object approaching the host vehicle Bs from a diagonally rearward direction and to be notified to an occupant of the host vehicle Bs and is typically another vehicle Bt approaching the host vehicle Bs from a diagonally rearward direction. The detection-result output unit 406 is configured to output, to the warning device 5, a determination result when the notification-target determination unit 405 determines that a notification target is present.

### Operation Overview

An overview of operation according to the device configuration of the present embodiment will be described below together with effects achieved by the device configuration and by a method and a program executed thereby. In the following description, the device configuration according to the present embodiment and a method and a program executed thereby may be collectively referred to as the present embodiment.

The radar sensors 2 provided at rear-end corner portions of the vehicle body of the host vehicle Bs detect objects located rearward of and diagonally rearward of the host vehicle Bs. The driving-state sensor 3 detects the driving state of the host vehicle Bs. Based on object detection information from the radar sensors 2 and on detection results of the driving state of the host vehicle Bs from the driving-state sensor 3, the object detection device 4 detects another vehicle Bt approaching the host vehicle Bs from a diagonally rearward direction and notifies an occupant of the host vehicle Bs via the warning device 5.

FIG. 4A illustrates a situation in which the host vehicle Bs gradually approaches a roadside fixed object Bx during diagonal travel associated with a lane change. The roadside fixed object Bx is a stationary fixed object provided along a road on which the host vehicle Bs travels and is, for example, a wall, a guardrail, a hedge, or the like. FIG. 4B illustrates a situation in which the host vehicle Bs gradually approaches another vehicle Bt traveling diagonally rearward in an adjacent lane during diagonal travel associated with a lane change.

An appearance of the roadside fixed object Bx as viewed from the radar sensors 2 in the scene of FIG. 4A and an appearance of the other vehicle Bt as viewed from the radar sensors 2 in the scene of FIG. 4B are substantially the same. Accordingly, while the host vehicle Bs travels diagonally during a lane change as illustrated in FIG. 4A, the object detection device may erroneously recognize the roadside fixed object Bx as another vehicle Bt approaching the host vehicle Bs from a diagonally rearward direction, as illustrated in FIG. 4B. In this case, a ghost recognized as another vehicle Bt due to the erroneous determination caused by the roadside fixed object Bx is generated on the roadside fixed object Bx.

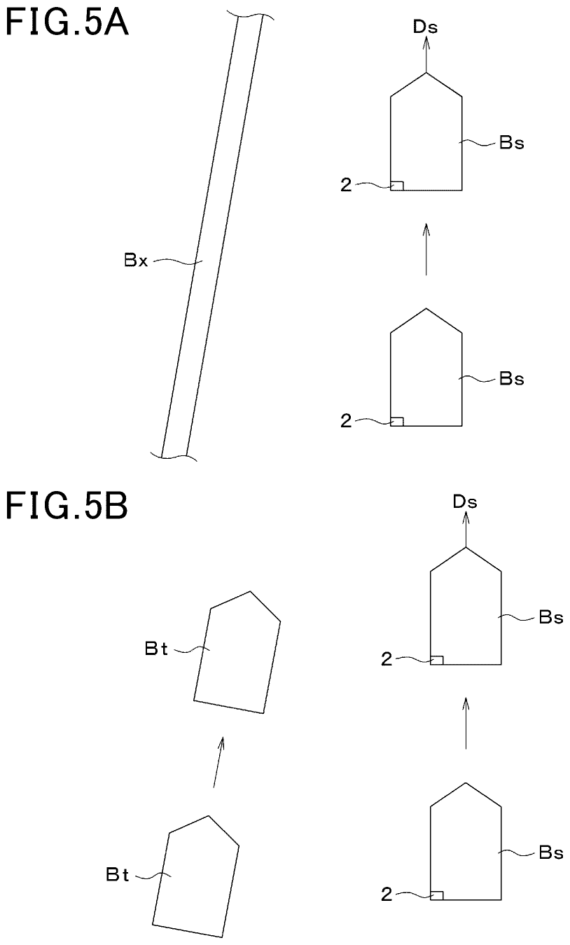

FIG. 5A illustrates a situation in which the host vehicle Bs gradually approaches a roadside fixed object Bx extending in a direction intersecting the travel direction Ds of the host vehicle while the host vehicle Bs is traveling straight. Such a situation is often observed, for example, at a section where the number of lanes decreases on a highway. FIG. 5B illustrates a situation in which the host vehicle Bs is traveling straight and another vehicle Bt traveling diagonally rearward in an adjacent lane gradually approaches the host vehicle Bs during a lane change.

An appearance of the roadside fixed object Bx as viewed from the radar sensors 2 in the scene of FIG. 5A and an appearance of the other vehicle Bt as viewed from the radar sensors 2 in the scene of FIG. 5B are substantially the same. Accordingly, for example, while the host vehicle Bs is traveling straight as illustrated in FIG. 5A, the object detection device may erroneously recognize the roadside fixed object Bx extending obliquely as another vehicle Bt approaching from a diagonally rearward direction, as illustrated in FIG. 5B. Also in this case, a ghost recognized as another vehicle Bt due to the erroneous determination caused by the roadside fixed object Bx is generated on the roadside fixed object Bx.

When detection of such a ghost causes an unnecessary false warning or erroneous notification to an occupant of the host vehicle Bs, usability of this type of blind-spot monitoring system deteriorates. Accordingly, it is desirable to suppress ghost detection caused by a roadside fixed object Bx extending in a direction intersecting a travel direction Ds of the host vehicle.

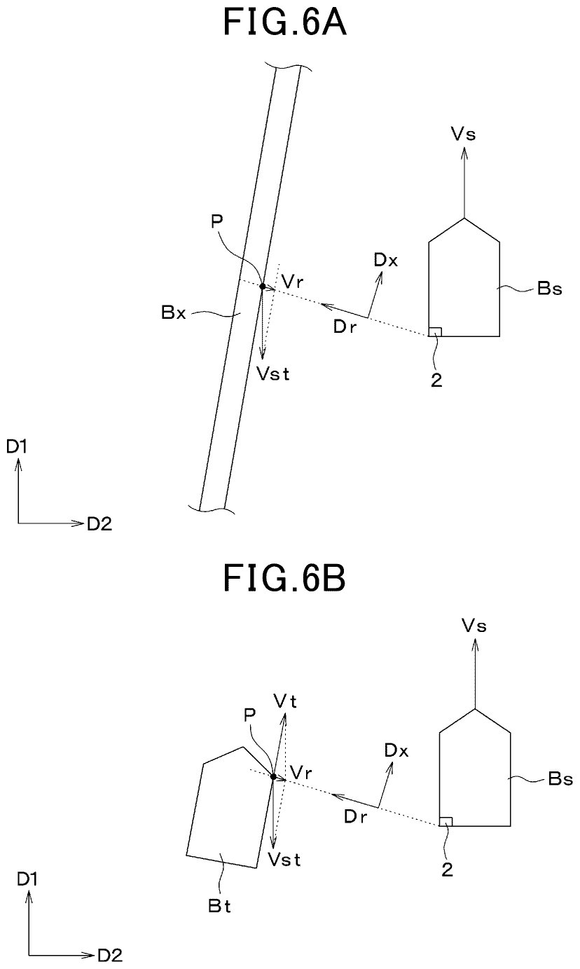

Object observation conditions obtained from the radar sensors 2 in a case of a roadside fixed object Bx extending in a direction intersecting a travel direction Ds of a host vehicle and in a case of another vehicle Bt approaching the host vehicle Bs from a diagonally rearward direction will be described in detail with reference to FIGS. 6A and 6B. In FIGS. 6A and 6B, illustration is based on two-dimensional coordinates having the vehicle longitudinal direction D1 as a vertical axis and the vehicle lateral direction D2 as a horizontal axis in order to generalize the situations of FIGS. 4A to 5B.

In FIGS. 6A and 6B, the observation point P is a reflection point. A radar-observed velocity vector Vr is a vector indicating an observed velocity of the observation point P, that is, a relative movement velocity with respect to the radar sensor 2. A host-vehicle movement velocity vector Vs is a vector indicating a ground-relative movement velocity of the host vehicle Bs. A relative velocity vector Vst is a vector acquired by reversing the direction of the host-vehicle movement velocity vector Vs. A target-observed velocity vector Vt is a vector indicating a ground-relative movement velocity of the observation point P. These vectors correspond to a ghost determination time point.

Referring to FIGS. 6A and 6B, a range direction Dr is a direction from the radar sensor 2 toward the observation point P. A cross-range direction Dx is a direction intersecting the range direction Dr and is typically a direction perpendicular to the range direction Dr. In FIGS. 6A and 6B, the cross-range direction Dx is illustrated as a direction perpendicular to the range direction Dr.

When a ghost is detected due to the roadside fixed object Bx extending obliquely as illustrated in FIG. 6A, the radar-observed velocity vector Vr and the target-observed velocity vector Vt are observed in a manner as illustrated in FIG. 6B. The radar-observed velocity vector Vr is directed toward the radar sensor 2, that is, toward the host vehicle Bs. The target-observed velocity vector Vt tilts toward the host vehicle Bs relative to the vehicle longitudinal direction D1. Such a situation appears when the roadside fixed object Bx as a stationary object exists in the cross-range direction Dx of the observation point P, as illustrated in FIG. 6A.

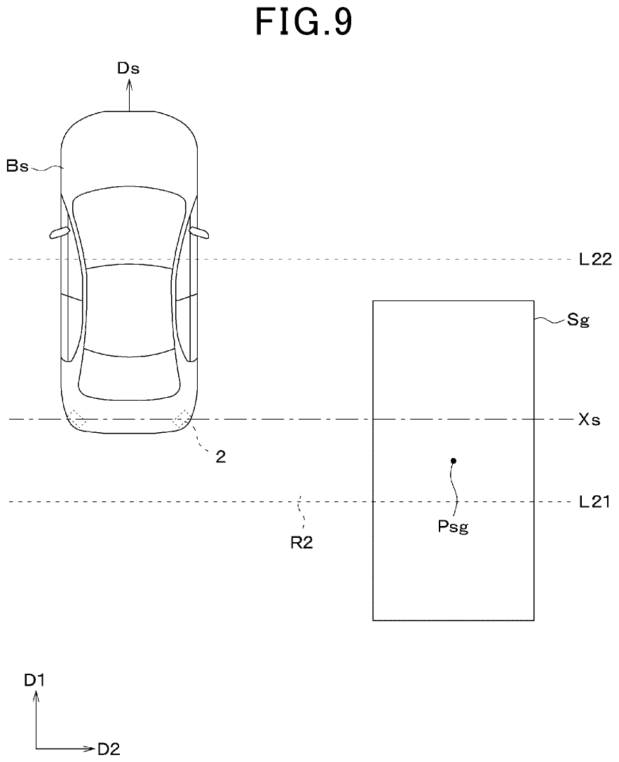

Accordingly, in the present embodiment, the ghost determination unit 404 is configured to determine that the segment Sg is a ghost when the segment information meets the ghost determination condition. The ghost determination condition includes first to fourth conditions described later. Specifically, the ghost determination condition is a logical AND of the first through fourth conditions, that is, all of the conditions are met. Each of the first to fourth conditions will be described in detail below using FIGS. 6A to 9.

The first condition is that the target-observed velocity vector Vt, which has a travel direction of the segment Sg, is directed along the cross-range direction Dx, that is, is parallel to the cross-range direction Dx or forms a small angle therewith. In other words, the first condition is that an angle between the target-observed velocity vector Vt and the cross-range direction Dx falls within a predefined range. The direction of the target-observed velocity vector Vt corresponds to the travel direction of the segment.

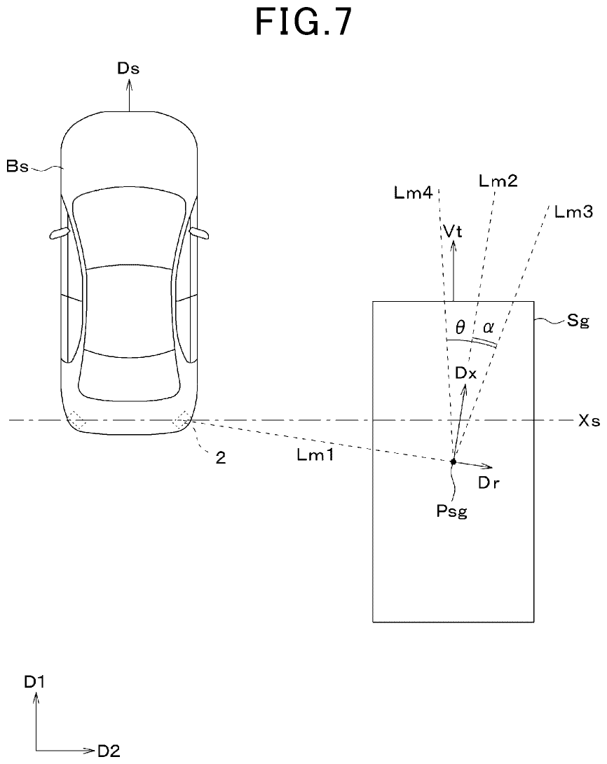

More specifically, referring to FIG. 7, a virtual straight line Lm1 is drawn from the radar sensor 2 that detected the segment Sg to a segment center point Psg. The segment center point Psg is a geometric center point of the rectangular segment Sg. The virtual straight line Lm1 is formed in the range direction Dr. Next, a perpendicular line Lm2 is drawn from the segment center point Psg to the virtual straight line Lm1. The perpendicular line Lm2 is formed in the cross-range direction Dx.

Subsequently, a first boundary line Lm3 is drawn by tilting the perpendicular line Lm2 by α degrees to one side about the segment center point Psg, and a second boundary line Lm4 is drawn by tilting the perpendicular line Lm2 by θ degrees to the other side. When the target-observed velocity vector Vt falls between the first boundary line Lm3 and the second boundary line Lm4, the first condition is met.

α and θ are adjustment values for allowing the first condition to be met even when the target-observed velocity vector Vt is not completely parallel to the cross-range direction Dx and may be optimized through calibration or computer simulation. That is, α and θ are set to small values (for example, a few degrees to about 5 degrees) such that the target-observed velocity vector Vt is determined to be directed along the cross-range direction Dx. α and θ may have the same value or different values.

The second condition is that the target-observed velocity vector Vt intersects the travel direction Ds of the host vehicle forward of the host vehicle Bs, where the travel direction Ds corresponds to a host-vehicle movement velocity vector Vs. Specifically, as illustrated in FIG. 6B, the second condition is that an angle between the target-observed velocity vector Vt and the host-vehicle movement velocity vector Vs is greater than or equal to a predefined angle and that the target-observed velocity vector Vt tilts toward the host vehicle Bs relative to the vehicle longitudinal direction D1. The predefined angle may be optimized through calibration or computer simulation and is, for example, about 7 to 10 degrees.

The third condition is defined in consideration of a tendency that a ghost of this type suddenly appears at a position laterally and slightly rearward of the host vehicle Bs. That is, when an actual other vehicle Bt approaches the host vehicle Bs from a diagonally rearward direction, a position of a segment Sg corresponding to the other vehicle Bt is typically located rearward of the host vehicle Bs by a certain extent, and typically rearward of the notification region, at a time point when the segment Sg is generated, that is, at a tracking start time point.

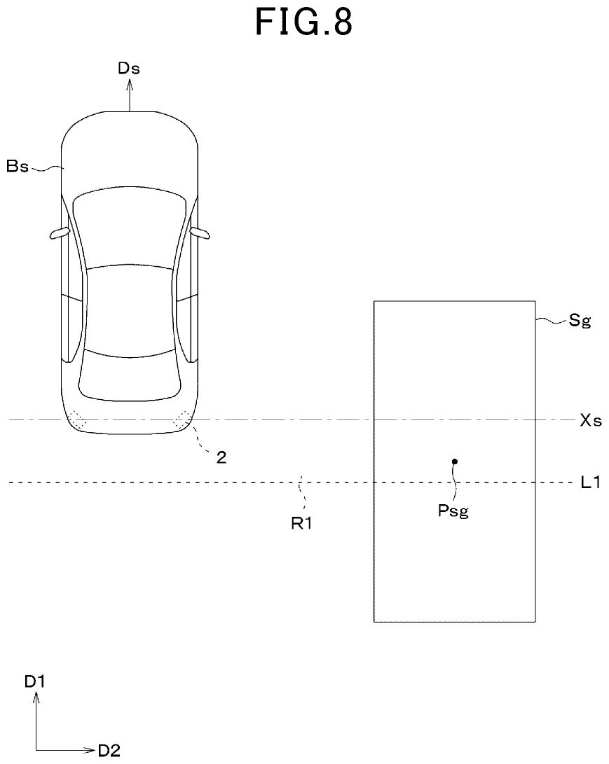

Accordingly, as illustrated in FIG. 8, the third condition is that a longitudinal position of the segment center point Psg is located within a first region R1 at a time point when the segment Sg is generated. The first region R1 is a region forward of a boundary position L1, that is, on the travel-direction Ds side of the host vehicle. The boundary position L1 is set with reference to a sensor longitudinal position Xs, which is a mounting position of the radar sensors 2 in the vehicle longitudinal direction D1. Specifically, the boundary position L1 is set rearward of the sensor longitudinal position Xs by a predefined distance. Such a predefined distance, that is, a margin distance, may be optimized through calibration or computer simulation and is, for example, about 1 to several meters.

The fourth condition is also defined from the same viewpoint as the third condition. That is, the third condition is that a position of the segment Sg at a generation time point corresponds to a ghost occurrence position. The fourth condition is that a current position of the segment Sg corresponds to the ghost occurrence position. Specifically, the fourth condition is that a longitudinal position of the segment center point Psg is within a second region R2 at a time point when it is determined whether the segment Sg is a ghost. The region R2 corresponds to a lateral region of radar sensor 2 where this type of ghost is likely to occur.

Specifically, the second region R2 is a band-shaped region having longitudinal positions between a first reference position L21 and a second reference position L22. The first reference position L21 is a position rearward of the sensor longitudinal position Xs. The second reference position L22 is a position forward of the sensor longitudinal position Xs. The sensor longitudinal position Xs is located between the first reference position L21 and the second reference position L22 but does not need to be a center position. A distance between the sensor longitudinal position Xs and the first reference position L21 and a distance between the sensor longitudinal position Xs and the second reference position L22 may be optimized through calibration or computer simulation and are each, for example, about 1 to 3 meters.

Use of the first to fourth conditions enables preferable determination as to whether the segment Sg is a ghost. However, depending on variations in position or angle of the detected segment Sg, hunting may occur in the determination.

Accordingly, the present embodiment makes processing, which would be applied when determining that a segment Sg is a ghost, inapplicable to a segment Sg previously determined as a notification target. This configuration enables provision of a hysteresis characteristic for suppressing hunting.

Specifically, for example, the ghost determination unit 404 excludes, from ghost determination processing, a segment Sg previously determined as a notification target. Alternatively, for example, even when the ghost determination unit 404 determines that a segment Sg is a ghost, the notification-target determination unit 405 makes the determination that the segment Sg is a ghost inapplicable when the segment Sg has previously been determined as a notification target. A period for such exclusion or inapplicability may be a predefined period or until the segment Sg is lost.

Thus, according to the present embodiment, an unnecessary false warning or erroneous notification due to detection of a ghost caused by the roadside fixed object Bx extending in a direction intersecting the travel direction Ds of the host vehicle can be preferably suppressed. According to the present embodiment, more reliable detection of an object approaching the host vehicle Bs from a diagonally rearward direction enables preferable suppression of occurrence of false warnings or erroneous notifications.

### Example Operation

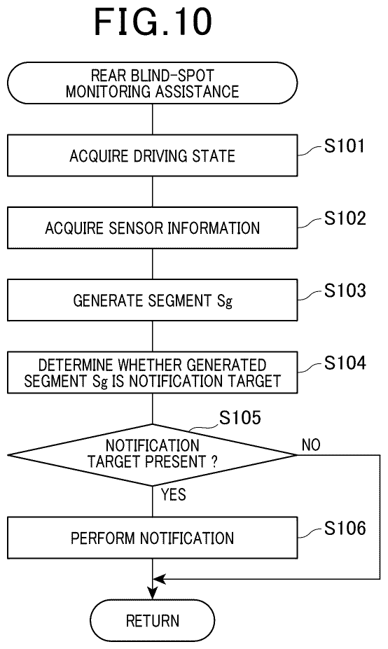

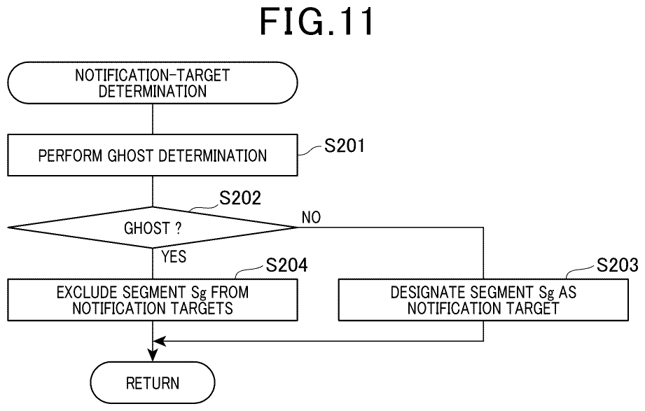

FIG. 10 illustrates, as a flowchart, a routine corresponding to an object detection program according to the present embodiment, that is, a rear blind-spot monitoring assistance program. In the flowchart of FIG. 10, S is an abbreviation for step. The same applies to the flowcharts of FIG. 11 and subsequent figures.

The processor 41 performs an object detection method according to the present embodiment by loading a rear blind-spot monitoring assistance program according to the present embodiment from the storage medium 42 and activating the program at predefined time intervals (for example, 10 msec). When such a program is activated, the processor 41 first sequentially performs processing at steps S101 to S105.

At step S101, the processor 41 acquires a driving state of the host vehicle Bs. At step S102, the processor 41 acquires information on transmission and reception results of radar waves by the radar sensors 2. At step S103, the processor 41 generates a segment Sg based on the driving state acquired at step S101 and the information on the transmission and reception results of radar waves acquired at step S102. Depending on the transmission and reception results of radar waves, no segment Sg may be generated at step S103.

At step S104, the processor 41 determines whether the segment Sg generated at step S103 is a notification target. The processing at this step is hereinafter referred to as notification-target determination. At step S105, the processor 41 determines whether a segment Sg designated as a notification target is present.

When a segment Sg that is a notification target is present (that is, when the answer at step S105 is YES), the processor 41 performs processing at step S106 and then terminates the routine. At step S106, the processor 41 performs a notification operation for the segment Sg that is the notification target. That is, the processor 41 causes the warning device 5 to output a notification corresponding to presence of another vehicle Bt approaching the host vehicle Bs from a diagonally rearward direction.

When no segment Sg that is a notification target is present (that is, when the answer at step S105 is NO), the processor 41 skips processing at step S106 and terminates the routine. That is, in this case, notification corresponding to presence of another vehicle Bt approaching the host vehicle Bs from a diagonally rearward direction is not performed.

FIG. 11 illustrates, as a flowchart, details of notification-target determination at step S104 in FIG. 10. The notification-target determination illustrated in FIG. 11 is repeatedly performed a number of times corresponding to the number of segments Sg generated at step S103 in FIG. 10.

When the notification-target determination is initiated, at step S201, the processor 41 performs ghost determination for determining whether the segment Sg that is a current determination target is a ghost. That is, the processor 41 determines whether the ghost determination condition described above is met. Details of the ghost determination will be described later.

Next, at step S202, the processor 41 determines whether the answer to ghost determination at step S201 is YES, that is, whether the segment Sg that is the current determination target is a ghost.

When the segment Sg is not a ghost (that is, when the answer at step S202 is NO), the processor 41 performs processing at step S203 and then terminates the notification-target determination for the segment Sg that is the current determination target. At step S203, the processor 41 designates the segment Sg that is a current determination target as a notification target.

When the segment Sg is a ghost (that is, when the answer at step S202 is YES), the processor 41 performs processing at step S204 and then terminates the notification-target determination for the segment Sg that is the current determination target. At step S204, the processor 41 excludes the segment Sg that is the current determination target from notification targets.

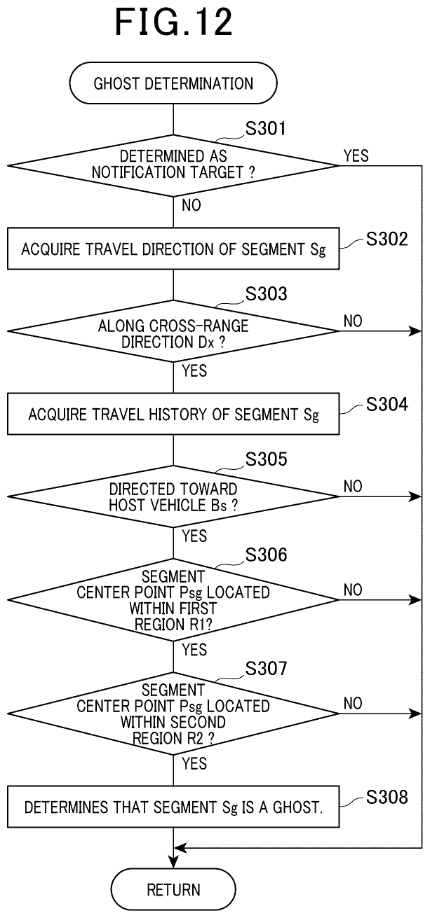

FIG. 12 illustrates, as a flowchart, details of ghost determination at step S201 in FIG. 11. First, at step S301, the processor 41 determines whether the segment Sg that is the current determination target has been determined as a notification target.

When the segment Sg that is a current determination target has been previously determined as a notification target (that is, when the answer at step S301 is YES), the processor 41 skips processing at step S302 and subsequent steps. The processor 41 then terminates ghost determination processing for that segment Sg. This configuration makes processing, which would be applied when determining that a segment Sg is a ghost, inapplicable to the segment Sg previously determined as a notification target. That is, the segment Sg previously determined as a notification target is excluded from ghost determination processing.

When the segment Sg that is the current determination target has not been determined as a notification target (when the answer at step S301 is NO), the processor 41 proceeds to steps S302 and S303. At step S302, the processor 41 acquires a travel direction of the segment Sg, that is, an orientation of the target-observed velocity vector Vt. At step S303, the processor 41 determines whether the travel direction of the segment Sg acquired at step S302 is a direction along the cross-range direction Dx. The determination at step S303 corresponds to determination as to whether the first condition is met.

When the travel direction of the segment Sg is not a direction along the cross-range direction Dx (that is, when the answer at step S303 is NO), the processor 41 skips processing at step S303 and subsequent steps and terminates ghost determination processing for the segment Sg that is the current determination target. In this case, a determination that the segment Sg is not a ghost is made. As described later, in this case, the processor 41 may proceed to another type of ghost determination.

When the travel direction of the segment Sg is a direction along the cross-range direction Dx (that is, when the answer at step S303 is YES), the processor 41 proceeds to step S304. At step S304, the processor 41 acquires a travel history of the segment Sg that is the current determination target. At step S305, the processor 41 determines whether the travel history acquired at step S304 includes a moment at which the vector is directed toward the host vehicle Bs. The determination at step S305 corresponds to determination as to whether the second condition is met.

When the second condition is not met (that is, when the answer at step S305 is NO), the processor 41 skips all processing at step S306 and subsequent steps and terminates ghost determination processing for the segment Sg that is the current determination target. In this case, a determination that the segment Sg is not a ghost is made. As described later, in this case, the processor 41 may proceed to another type of ghost determination.

When the second condition is met (that is, when the answer at step S305 is YES), the processor 41 proceeds to step S306. At step S306, the processor 41 determines whether the segment center point Psg at a time point when the segment Sg is generated is located within the first region R1. The determination at step S306 corresponds to determination as to whether the third condition is met.

When the third condition is not met (that is, when the answer at step S306 is NO), the processor 41 skips processing at step S307 and subsequent steps and terminates ghost determination processing for the segment Sg that is the current determination target. In this case, a determination that the segment Sg is not a ghost is made. As described later, in this case, the processor 41 may proceed to another type of ghost determination. When the third condition is met (that is, when the answer at step S306 is YES), the processor 41 proceeds to step S307.

At step S307, the processor 41 determines whether the current segment center point Psg is located within the second region R2. The determination at step S307 corresponds to determination as to whether the fourth condition is met. When the fourth condition is met (that is, when the answer at step S307 is YES), the processor 41 proceeds to step S308. At step S308, the processor 41 determines that the segment Sg that is the current determination target is a ghost.

When the fourth condition is not met (that is, when the answer at step S307 is NO), the processor 41 skips processing at step S308 and terminates ghost determination processing for the segment Sg that is the current determination target. In this case, a determination that the segment Sg is not a ghost is made. As described later, in this case, the processor 41 may proceed to another type of ghost determination.

### Modifications

The present disclosure is not limited to the embodiments and specific examples described above. Therefore, the above embodiments and the like can be modified as appropriate. Representative modifications will be described below. In the description of the following modifications, differences from the above embodiments and the like will be mainly described. Further, in the above embodiments and the following modifications, the same reference numerals are given to parts that are the same as or equivalent to each other. Therefore, in the description of the following modifications, for components having the same reference numerals as those in the above embodiments and the like, the descriptions in the above embodiments and the like can be applied as appropriate unless there is a technical inconsistency or special additional explanation.

The present disclosure is not limited to the specific applications or device configurations illustrated in the above embodiments. For example, the host vehicle Bs may be a so-called ordinary-sized vehicle, a large-sized vehicle, or a two-wheeled or three-wheeled vehicle. That is, no particular limitation is imposed on a type, a shape, or a size of a vehicle body. The same applies to the other vehicle Bt.

The radar sensors 2 are not limited to having a detection region diagonally rearward of the host vehicle Bs. That is, for example, the radar sensors 2 may have detection regions located behind, diagonally rearward of, and to the left and right sides of the host vehicle Bs. Further, no particular limitation is imposed on a mounting position or a number of radar sensors 2 mounted to the host vehicle Bs. That is, the host vehicle Bs may be equipped with either front-side sensors having detection regions located diagonally forward of the host vehicle Bs or a front sensor having a detection region located forward of the host vehicle Bs.

The object detection device 4 may be an ECU for driving control of the host vehicle Bs. Such an ECU may also be referred to as a driving-control ECU, and may be a driving-assistance ECU or an autonomous-driving ECU. That is, detection results acquired by the object detection device 4 may be used not only for providing a notification to an occupant but also for motion control of the host vehicle Bs.

A driving-assistance ECU is an ECU configured to be capable of implementing a driving automation level 1 or 2 defined in a standard “SAE J3016” published by SAE International. An autonomous-driving ECU is an ECU configured to be capable of implementing any of driving automation levels 3 to 5 defined in the same standard. That is, the on-board system 1 may be a driving-assistance system or an autonomous-driving system.

All or part of the object detection device 4 may be configured to include a digital circuit capable of implementing the above-described functions or operations, such as an ASIC or an FPGA. ASIC is an abbreviation for Application Specific Integrated Circuit. FPGA is an abbreviation for Field Programmable Gate Array. That is, in the object detection device 4, an on-board microcomputer section and a digital circuit section may coexist.

A computer program according to the present disclosure that enables execution of various operations, procedures, or processes described in the above embodiments may be downloaded to or upgraded in a non-volatile rewritable memory via V2X communication using a communication device. V2X is an abbreviation for Vehicle to X. Alternatively, such a computer program may be downloaded or upgraded via a terminal device provided at a manufacturing factory, a maintenance facility, a dealership, or the like for the host vehicle Bs. A non-volatile rewritable memory that stores such a computer program is not limited to a semiconductor memory such as a flash memory, and may be an optical recording medium or a magnetic recording medium.

Each of the above-described functional blocks and processes may be realized by a dedicated computer provided by configuring a processor and a memory programmed to implement one or more functions embodied by computer programs. Alternatively, each of the functional blocks and processes described above may be realized by a dedicated computer provided by configuring a processor with one or more dedicated hardware logic circuits. Alternatively, each of the functional configurations and processes described above may be implemented by one or more dedicated computers. Each dedicated computer may be configured by a combination of one or more processors and one or more memories programmed to implement one or more functions, and one or more other processors constituted by one or more hardware logic circuits.

Further, the computer program may also be stored in a computer-readable non-transitory tangible storage medium as an instruction to be executed by a computer. That is, each of the above-described functional blocks and processes can also be represented as a computer program including procedures for implementing each of the above-described functions or methods, or as a non-transitory tangible storage medium storing said program.

The present disclosure is not limited to the specific functions or operational modes illustrated in the above embodiments. For example, in addition to a ghost caused by a roadside fixed object Bx extending in a direction intersecting a travel direction Ds of a host vehicle, other types of ghosts derived from stationary objects or moving objects may occur. Therefore, after determining these ghosts, a final ghost determination may be made by integrating all determination results.

It goes without saying that the elements constituting the above embodiments are not necessarily essential unless explicitly stated to be essential or unless they are clearly understood to be essential in principle. In addition, when a numerical value such as the number, value, amount, or range of a component in any of the above-described embodiments is mentioned, it should not be construed as being limited to that specific number or value unless expressly stated otherwise or unless it is clearly limited in principle. Furthermore, when the shape, direction, positional relationship, or the like of a component in any of the embodiments is described, it is not intended to be limited thereto unless explicitly stated otherwise or unless such limitation is clearly required in principle.

Expressions such as “acquire,” “calculate,” “estimate,” “detect,” and “sense” may be used interchangeably, provided that no technical inconsistency arises. Furthermore, the expressions “exceeding a threshold” and “greater than or equal to a threshold” may be used interchangeably as long as they do not cause technical contradiction. The same applies to “less than a threshold” and “equal to or less than a threshold.”

The modifications are not limited to the examples described above. For example, all or part of one of the specific examples may be combined with all or part of another, provided that no technical contradiction arises. Furthermore, any or all of the specific examples described above may be combined with any or all of the above modification examples, provided that no technical contradiction arises.

What is claimed is:

1. An object detection device for detecting an object approaching a host vehicle from a diagonally rearward direction, the object detection device comprising:
a segment-information acquisition unit configured to acquire segment information about a position and a movement state of a segment, the segment being a region presumed to be an object and generated based on transmission and reception results of radar waves by a radar sensor having detection regions located diagonally rearward of the host vehicle; and
a ghost determination unit configured to determine, based on the segment information, whether the segment is a ghost, wherein
the ghost determination unit is further configured to determine that the segment is a ghost when the segment information meets a ghost determination condition, the ghost determination condition including:
a first condition that a segment travel direction of the segment is a direction along a cross-range direction of the radar sensor;
a second condition that the segment travel direction and a host-vehicle travel direction of the host vehicle intersect forward of the host vehicle; and
a third condition that, at a time point when the segment is generated, a center position of the segment is located forward of a predefined boundary position defined with reference to a mounting position of the radar sensor in a longitudinal direction of the host vehicle.

2. The object detection device of claim 1, wherein
the ghost determination condition further includes a fourth condition that, at a time point when it is determined whether the segment is the ghost, the center position is located between a first reference position that is rearward of the mounting position of the radar sensor and a second reference position that is forward of the mounting position of the radar sensor in the vehicle longitudinal direction.

3. The object detection device of claim 1, wherein
the first condition is that an angle between the segment travel direction and the cross-range direction is within a predefined range.

4. The object detection device of claim 1, wherein
the second condition includes that an angle between the segment travel direction and the host-vehicle travel direction is greater than or equal to a predefined angle.

5. The object detection device of claim 1, further comprising a notification-target determination unit configured to determine, based on a determination result of the ghost determination unit, a notification target for notifying an occupant of the host vehicle of presence of the object, wherein,
for a segment previously determined as the notification target, processing that would be applied when the segment is determined to be the ghost is made inapplicable.

6. The object detection device of claim 1, wherein
the ghost is generated due to a fixed object provided along a road on which the host vehicle is traveling.

7. The object detection device of claim 2, wherein
the ghost determination condition is a logical AND of the first through fourth conditions.

8. An object detection method of detecting an object approaching the host vehicle from a diagonally rearward direction, the method comprising:
acquiring segment information about a position and a movement state of a segment, the segment being a region presumed to be an object and generated based on transmission and reception results of radar waves by a radar sensor having detection regions located diagonally rearward of the host vehicle; and
determining, based on the segment information, whether the segment is a ghost, wherein
the determining includes determining that the segment is a ghost when the segment information meets a ghost determination condition, the ghost determination condition including:
a first condition that a segment travel direction of the segment is a direction along a cross-range direction of the radar sensor;
a second condition that the segment travel direction and a host-vehicle travel direction of the host vehicle intersect forward of the host vehicle; and
a third condition that, at a time point when the segment is generated, a center position of the segment is located forward of a predefined boundary position defined with reference to a mounting position of the radar sensor in a longitudinal direction of the host vehicle.

9. A computer program product comprising instructions which, when executed by a computer, cause the computer to perform an object detection method comprising:
acquiring segment information about a position and a movement state of a segment, the segment being a region presumed to be an object and generated based on transmission and reception results of radar waves by a radar sensor having detection regions located diagonally rearward of the host vehicle; and
determining, based on the segment information, whether the segment is a ghost, wherein
the determining includes determining that the segment is a ghost when the segment information meets a ghost determination condition, the ghost determination condition including:
a first condition that a segment travel direction of the segment is a direction along a cross-range direction of the radar sensor;
a second condition that the segment travel direction and a host-vehicle travel direction of the host vehicle intersect forward of the host vehicle; and
a third condition that, at a time point when the segment is generated, a center position of the segment is located forward of a predefined boundary position defined with reference to a mounting position of the radar sensor in a longitudinal direction of the host vehicle.

10. The computer program product of claim 9, wherein
the computer program product is a non-transitory tangible storage medium.
